(19) United States
(12) Patent Application Publication
(10) Pub. No.: US 2025/0052285 A1
(43) Pub. Date: Feb. 13, 2025

(54) BELLOWS FOR PROTECTION OF TRANSMISSION JOINT

(71) Applicants: NEAPCO INTELLECTUAL PROPERTY HOLDINGS, LLC, Farmington, MI (US); NEAPCO EUROPE GMBH, Düren (DE)

(72) Inventors: Filip DUDA, Praszka (PL); Kamil KRUPA, Praszka (PL); Srinath PRAKASH, Praszka (PL)

(73) Assignees: NEAPCO INTELLECTUAL PROPERTY HOLDINGS, LLC, Farmington, MI (US); NEAPCO EUROPE GMBH, Düren (DE)

(21) Appl. No.: 18/721,257

(22) PCT Filed: Dec. 16, 2022
(86) PCT No.: PCT/EP2022/086298

§ 371 Date: Jun. 18, 2024

(30) Foreign Application Priority Data
Dec. 28, 2021 (DE) 10 2021 006 381.3

(51) Int. Cl. F16D 3/84; F16J 3/04

(52) U.S. Cl. CPC F16D 3/845; F16J 3/041

(57) ABSTRACT

Bellows (10) for the protection of parts of a transmission joint (40), wherein the bellows (10) is in the form of a hollow tubular body that is open at each of its ends and has a fastening region (21;22) at each of its open ends. The two fastening regions (21;22) have cross-sections with different outer diameters and run essentially in parallel to a longitudinal axis (X) of the bellows (10), and these end side fastening regions (21;22) are interconnected by a deformable wall (30) that runs transverse to the longitudinal axis (X) of the bellows (10), wherein the deformable wall (30) forms at least one fold (32) between the two fastening regions (21;22). Thereby, a first fastening region (21) with the larger outer diameter D is extended in the direction of a second fastening region (22) with the smaller outer diameter d by means of a circumferential extension section (50) with a circular free edge (51) and the deformable wall (30) is connected to this extension section (50) at a first connection line (60) which is located before the free edge (51) of the extension section (50). The outer surface of the extension section (50) is straight at least between the first connection line (60) and the free edge (51).

The disclosure relates to a bellows for the protection of parts of a transmission joint, wherein the bellows is in the form of a hollow tubular body that is open at each of its ends. The bellows has a fastening region at each of its open ends, wherein the two fastening regions have cross-sections with different outer diameters and run essentially in parallel to a longitudinal axis of the bellows. These end side fastening regions are interconnected by a deformable wall that runs transverse to the longitudinal axis of the bellows, wherein the deformable wall forms at least one fold between the two fastening regions.

Rolling bellows or boots of the aforementioned type are known from the prior art. The bellows can be mounted on a transmission joint by means of two fastening regions, whereby a first fastening region is fastened to an outer joint member and a second fastening region is fastened to the drive shaft that is received in an inner joint member. For instance, US 2011/0092352 A1 describes a rolling boot having a first fastening region intended for fastening to a joint housing and a second fastening region intended for fastening to a shaft. There is a fold region between these two fastening regions which can deform when the outer joint member and the inner joint member of a transmission joint are at an angle to each other. However, the fold region has to be designed so that undesired deformation and in particular the formation of bulges is prevented. The formation of bulges is also called buckling.

Often reinforcing ribs in the fold region are provided to prevent buckling of the boot when the outer joint member and the inner joint member of a transmission joint are at large angles to each other. It is also known to provide folds with specific forms, dimensions and parameters. However, there is still a need for simple and reliable solutions that can prevent buckling of a boot/bellows.

Therefore, the object of the invention is to provide a bellows with good flexibility and buckling avoidance.

According to the invention, this object is achieved by a bellows according to independent claim 1. Advantageous embodiments of this bellows can be derived from dependent claims 2-14.

The bellows according to the invention is used for the protection of parts of a transmission joint. Such bellows can also be called a boot. The transmission joint can be a constant velocity joint, for example. Constant velocity joints are common components in automotive vehicles for applications requiring a transmission of rotating motion such as constant velocity motion. Constant velocity joints are typically used in front wheel drive vehicles and rear wheel drive vehicles to transmit torque from a transmission of a vehicle to the drive wheels at a constant velocity or speed. Although, in certain applications, constant velocity joints can also be used in all wheel drive and four-wheel drive vehicles.

Common types of constant velocity joints include an outer joint member and an inner joint member. The outer joint member typically includes a hollow chamber which is open at one end and closed at an opposing end, with recesses and/or tracks formed in an inner wall thereof to receive transmission balls. The inner joint member has outer tracks to receive the transmission balls and the inner joint member is configured to receive a drive shaft of the vehicle. The outer joint member co-axially receives the inner joint member.

The bellows according to the invention can be mounted on a transmission joint by means of two fastening regions, whereby a first fastening region is fastened to the outer joint member and a second fastening region is fastened to the drive shaft that is received in the inner joint member of a transmission joint. Thereby, the bellows forms an inner space that is closed to the surroundings so that no dirt can enter the transmission joint. In addition, the inner space can be filled with a lubricant and no lubricant can leave the inner space.

According to the invention, the bellows is in the form of a hollow tubular body that is open at each of its ends and has a fastening region at each of its open ends. The two fastening regions have cross-sections with different outer diameters and run essentially in parallel to a longitudinal axis of the bellows. The first fastening region with the larger outer diameter can then be fastened to the outer joint member, whereas the second fastening region with a smaller outer diameter can be fastened to the drive shaft that is received in the inner joint member. Components of the transmission joint are then protected within the hollow tubular body.

The end side fastening regions are interconnected by a deformable wall that runs transverse to the longitudinal axis of the bellows, wherein the deformable wall forms at least one fold between the two fastening regions. The material of the deformable wall is flexible and can be a thermoplastic elastomer or rubber, for example. The rest of the bellows can be made of the same material, or at least the fastening regions can be made of a material that is less flexible. In addition, the bellows which includes at least the two fastening regions and the deformable wall can be one piece. In another embodiment, several parts are joined to form the bellows. In any case, when the outer joint member and the inner joint member of a joint move in relation to each other, the deformable wall can easily deform because of its flexible material. This is supported by the at least one fold, whereby the side flanks of the fold can move and bend freely. Furthermore, flexibility and stiffness can also be guaranteed by the geometry of the bellows.

According to the invention, a first fastening region with the larger outer diameter D is extended in the direction of a second fastening region with the smaller outer diameter d by means of a circumferential extension section with a circular free edge. This means that the first fastening region is extended by an extension section, whereby this extension section is not used for fastening the bellows to an outer joint member. Therefore, it can move freely and this circumferential extension section ends with a circular free edge. The deformable wall is connected to this extension section at a first connection line which is located before the free edge of the extension section. This means that the deformable wall is not connected to the free edge at the end of the extension section, but it connects to the extension section at a certain distance to the free edge. Consequently, the first connection line is located at a certain distance to the free edge so that a collar or stiffener region is formed beyond this first connection line.

The collar is formed on the outside of the bellows. The distance a between the first connection line and the free edge of the collar is at least 2 mm, preferably at least 2,5 mm, more preferably at least 3 mm

Thereby, the outer surface of the extension section is straight at least between the first connection line and the free edge. This straight and flat collar provides proper boot flexibility and buckling avoidance. In one embodiment of the invention, a is the distance between the first connection line and the free edge of the extension section and a=(0,02 to 0,2)×D.

In one embodiment, the outer surface of the first fastening region and the outer surface of the extension section merge steplessly into each other. Thus, the outer diameter can increase or decrease successively, but preferably, there are no steps or abrupt changes of orientation of the outer surface of the first fastening region and the extension section. In particular, it is advantageous that the outer surface of the extension section is straight between the first fastening region and the free edge of the extension section.

In another embodiment of the invention, there can be one or more steps between the outer surface of the first fastening region and the outer surface of the extension section. A step means that the outer diameter of the bellows increases or decreases in an area. Preferably, the diameter decreases to form a step towards the inside. Alternatively, the extension section comprises one or more steps as described before. When the bellows is mounted to a transmission joint, the first fastening region is fastened to the outer joint member of the joint, whereby the outer joint member may protrude beyond the first fastening region in the axial direction towards the second fastening region. This means that the extension section lies in the area of the outer joint member. For example for these embodiments, a step can then be located in the extension section behind the end of the outer joint member so that the diameter decreases after the bellows passes the end of the outer joint member.

The deformable wall forms a flexible part, whereas the fastening regions form a relatively stiff part. Thereby, the deformable wall includes at least one fold which can be incorporated into the deformable wall in various ways. In one embodiment of the invention, the deformable wall forms a straight leg which is connected to the extension section at the first connection line. Therefore, the first part of the deformable wall starting at the extension section is straight. In particular, the deformable wall and the extension section intersect at an angle α of 45° to 90° on the inside of the bellows. In addition, it is preferred that the thickness b of the straight leg of the deformable wall is smaller than the thickness c of the circular free edge of the extension section.

In another embodiment of the invention, the second fastening region with the smaller outer diameter d is extended in the direction of the first fastening region with the larger outer diameter D by means of a circumferential neck section and the deformable wall is connected to this neck section at a second connection line. In addition, the deformable wall forms a fold between the straight leg and the neck section, whereby the fold is a convex bulge on the outside of the bellows. The radius R2 of the fold on the inside of the bellows is smaller than 12 mm, preferably smaller than 10 mm.

In addition, it is preferred that an angle β spans between the inner surface of the neck section and the longitudinal axis X of the bellows and this angle β is smaller than 15°. Further, the connection line at the connection of the deformable wall to the extension section axially lies closer to the second fastening region than the second connection line at the connection of the deformable wall to the neck section.

In one embodiment, the deformable wall forms a curved leg which is connected to the neck section at the second connection line, whereby the curved leg is concave on the outside of the bellows. This curved leg has a radius R1 on the outside of the bellows, which also is smaller than 12 mm, preferably smaller than 10 mm. The same applies for the transition from the straight leg of the deformable wall to the fold. This transition is curved and the radius R3 of this curved transition on the outside of the bellows is smaller than 12 mm, preferably smaller than 10 mm.

In particular with a combination of all these parameters, proper boot flexibility and buckling avoidance can be achieved. This has been analysed by the applicant compared to bellows without a stiffener region according to the invention.

The invention will be explained in greater detail below based on the attached figures. These must be viewed only as examples, and are not intended to limit the invention to the depicted embodiments. Shown on:

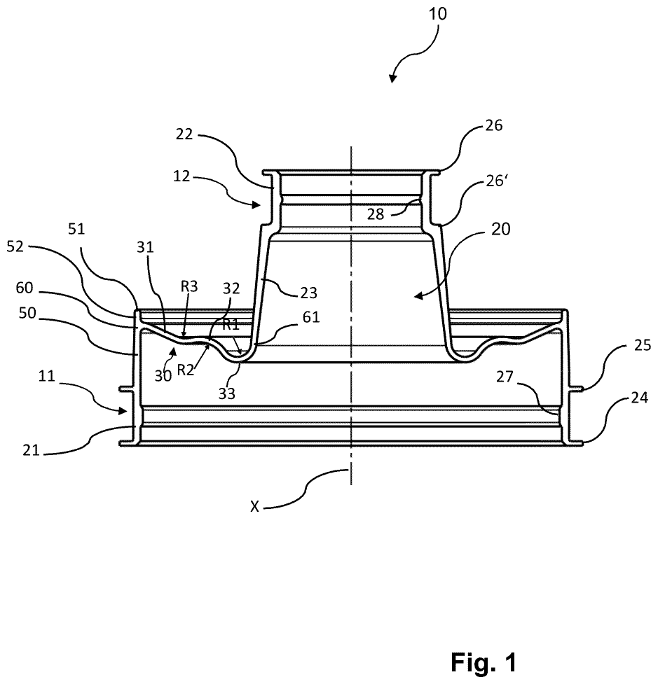

FIG. 1: a cross-sectional view of one embodiment of the bellows according to the invention;

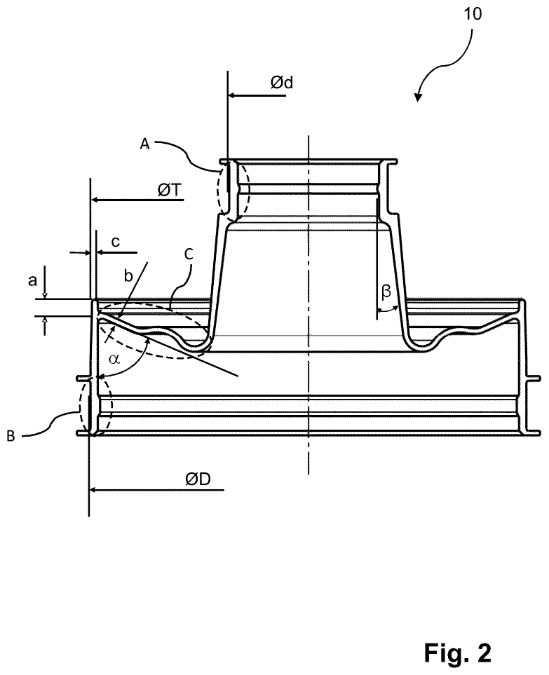

FIG. 2: the cross-sectional view of FIG. 1 indicating different functional regions of the bellows;

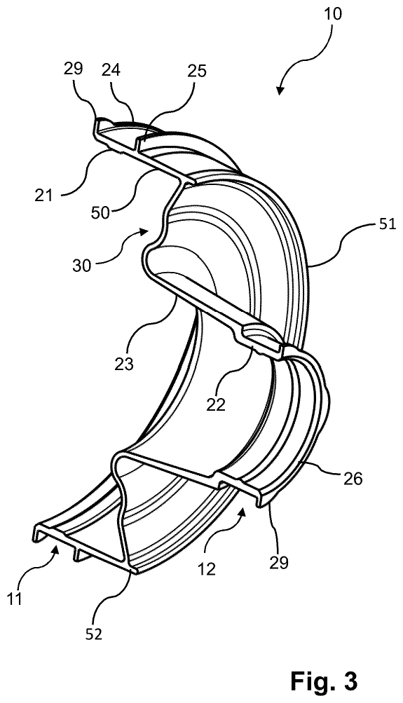

FIG. 3: a three-dimensional illustration of the cross-sectional view of the bellows of FIG. 1;

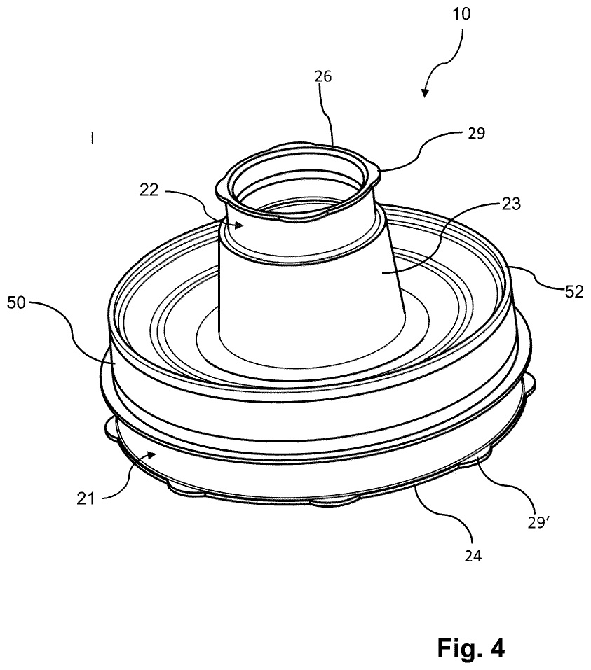

FIG. 4: a three-dimensional illustration of the bellows of FIG. 1;

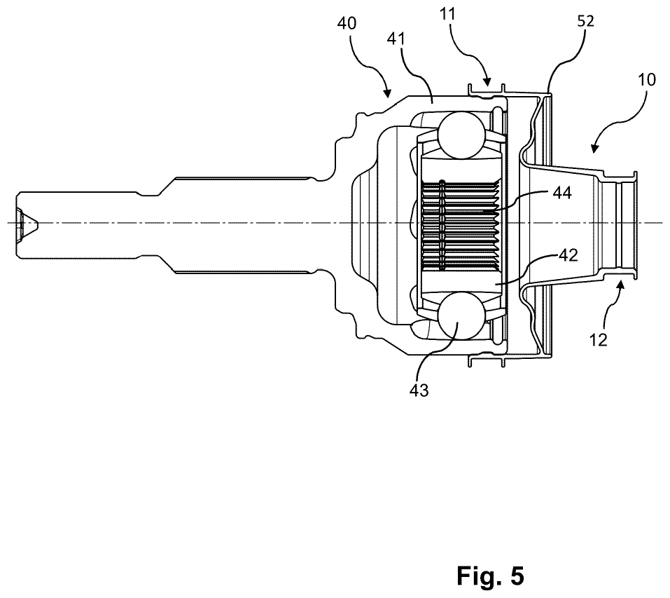

FIG. 5: a cross-sectional view of a bellows of FIG. 1 mounted on a transmission joint;

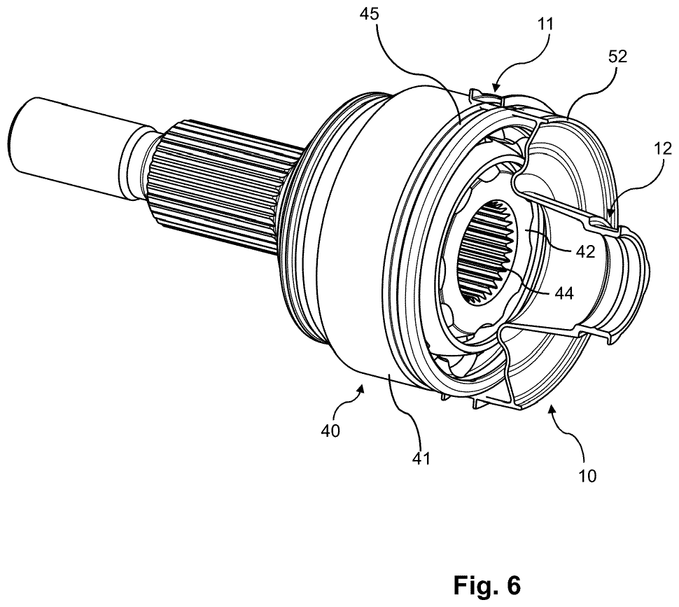

FIG. 6: a three-dimensional illustration of the assembly of FIG. 5;

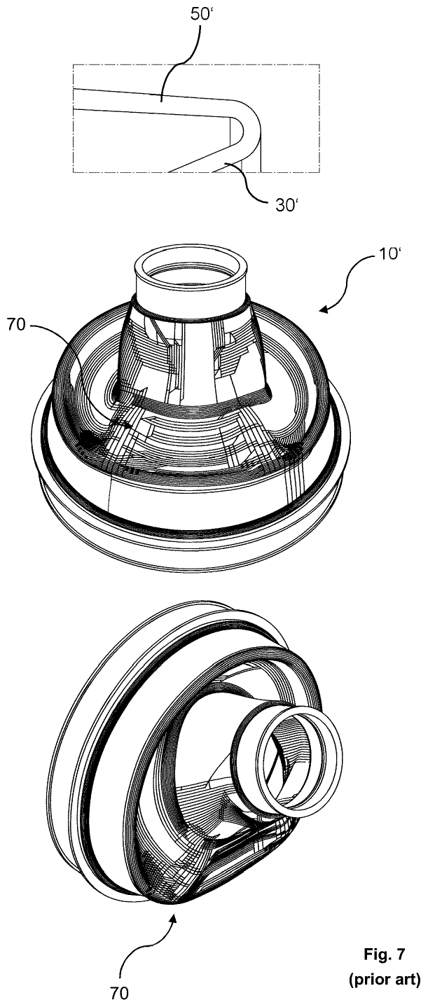

FIG. 7: a three-dimensional illustration of the buckling behaviour of a prior art bellows; and

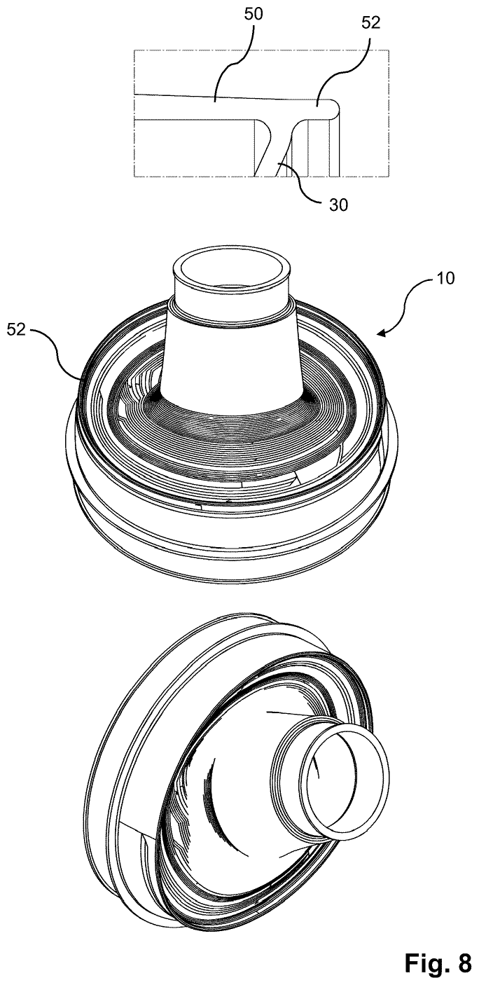

FIG. 8: a three-dimensional illustration of the behaviour of a bellows according to the invention without buckling.

FIGS. 1 and 2 each show a cross-sectional view of one embodiment of a bellows or boot 10 according to the invention. Thereby, FIG. 1 includes reference numerals to indicate the different parts of the bellows 10. In addition, FIG. 2 indicates the different functional regions of the bellows without reference numerals in order to increase the clarity of illustration. If parts or regions of the bellows 10 are described with respect to one of these figures, one has to consider that the main parts of the bellows 10 form an axisymmetric body in relation to the longitudinal axis X. Therefore, they are round and circumferential.

The bellows 10 can be used for the protection of parts of a transmission joint, whereby an exemplary assembly of a bellows 10 to a transmission joint 40 is shown in FIGS. 5 and 6. FIG. 7 shows the behavior of a bellows 10′ without a stiffener according to the invention, whereby the bellows 10′ undergoes a buckling when the outer joint member and the inner joint member of a transmission joint are at a large angle to each other. In contrast, FIG. 8 shows the improved behavior of a bellows 10 with a stiffener 52 according to the invention.

Thereby, the bellows 10 has the form of a hollow tubular body that is open at each of its ends and has a fastening region at each of its open ends. The two fastening regions 21 and 22 have cross-sections with different outer diameters and run essentially in parallel to the longitudinal axis X of the bellows 10. An inner space 20 is created within the tubular body and components of a transmission joint can be incorporated into this inner space 20. This inner space 20 also defines the inside of the bellows 10. The space outside the tubular body is the outside of the bellows.

A first fastening region 21 has a larger outer diameter D and a second fastening region 22 has a smaller outer diameter d. These fastening regions 21 and 22 basically have a hollow cylindrical shape with walls that run essentially in parallel to the longitudinal axis X. On the inside of each fastening region 21, 22, there is a ring 27 and 28 which interacts with a corresponding channel on the outer joint member of a transmission joint or a drive shaft. FIG. 6 shows such channel 45 on the outer surface of the outer joint member, for example. Each fastening region 21 and 22 is also part of a corresponding seat region A and B (see FIG. 2). Each seat region A and B is axially limited by lateral walls to hold fixing stripes within each seat region. For example, the first fastening region 21 of the seat region B has two outer lateral circumferential walls 24 and 25, which can be derived from FIG. 3. A seat 11 is formed between these two walls 24, 25 which can hold a fixing stripe. The second fastening region 22 also has a circumferential outer wall 26 and the other side the seat region A is limited by a step 26′. This step 26′ is formed by a neck section 23 that extends the second fastening region 22 in the direction of the first fastening region 21. A seat 12 is formed between this step 26′ and the wall 26.

The neck section 23 does not run in parallel to the longitudinal axis X. Instead, an angle B spans between the longitudinal axis X of the bellows 10 and the inner surface of the neck section 23. In addition, the thickness of the neck section 23 decreases in the direction from the second fastening region 22 towards the first fastening region 21. On the other side, an extension section 50 extends the first fastening region 21 in the direction of the second fastening region 22. This extension section 50 has a circumferential free edge 51. T is the outer diameter of the extension section 50 at its free edge 51 and D>T.

A deformable wall 30 connects the extension section 50 and the neck section 23. Thereby, the deformable wall 30 is connected to the extension section 50 at a first connection line 60 that is located before the free edge 51. Thereby, a collar or stiffener 52 is formed with the length a. This means, there is a distance a between the deformable wall 13 and the free edge 51. The thickness of this collar or stiffener 52 is indicated with the letter c in FIG. 2 and it can be seen that the connection between the extension section 50 and the deformable wall 30 forms an italic “T”.

The deformable wall 30 forms a flexible region C between the two fastening regions 21 and 22, in particular between the extension section 50 and the neck section 23. Thereby, the first connection line 60 between the deformable wall 30 and the extension section 50 axially lies closer to the second fastening region 22 than a second connection line 61 between the deformable wall 30 and the neck section 23. This is the reason why the deformable wall 30 forms a sink on the outside of the bellows 10 with the neck section 23 in the middle of the sink. Thereby, the deformable wall 30 has a straight leg 31 that is connected to the extension section 50. The angle α spans between the extension section 50 and this straight leg 31, whereby the angle α is between 45° and 90°.

The deformable wall 30 also has a curved leg 33 that is connected to the neck section 23 at the second connection line 61. A fold 32 is located between the straight leg 31 and the curved leg 33. This fold is a bulge which is convex when seen from the outside of the bellows 10. The radius R1 of the curved leg 33, the radius R2 of the fold 32 and the radius R3 of the transition from the straight leg 31 to the fold 32 is rather small. Preferably, these radii are smaller than 12 mm or even smaller than 10 mm. Besides, the thickness b of the straight leg 31 is smaller than the thickness c of the free edge 51.

The three-dimensional illustration of FIG. 4 shows the outer shape of the bellows 10. It shows the sink-like and concave outer form of the region between the extension section 50 and the neck section 23 in the middle. From this perspective it can also be seen that the outer walls 26 and 24 can comprise several bulges, wherein one of four bulges at the outer wall 26 is identified with the one reference number 29. One of eight bulges at the outer wall 24 is identified with the one reference number 29′. These bulges can be used to hold a clamp before the bellows 10 is clamped to a joint member/shaft

FIG. 5 shows a cross-sectional view of a bellows 10 of FIG. 1 mounted on a transmission joint 40. The transmission joint 40 is a constant velocity joint with an outer joint member 41 and an inner joint member 42. The outer joint member 41 has inner tracks and the inner joint member 42 has outer tracks, whereby transmission balls 43 are rotationally held in these tracks. The inner joint member 41 has an internal gearing 44 and a drive shaft with an external gearing can interlock with this internal gearing 44. The drive shaft is not shown in the figures. FIG. 6 shows the transmission joint 40 with the bellows 10 which is cut. The ring 27 of the first fastening region 21 is seated in the circumferential channel 45 on the outer surface of the outer joint member 41. When a drive shaft is connected to the inner joint member 42, the ring 28 will be seated in a circumferential channel on the drive shaft. Fixing stripes (not shown) can hold the seat regions A, B and 11, 12, respectively, on the outer joint member 41 and the drive shaft.

Compared to known bellows, the bellows 10 according to the invention with the stiffening collar 52 has the advantage of better boot flexibility and buckling avoidance. Bellows without such stiffening collar 52 tend to buckle at larger angles between the two joint members of a transmission joint. FIG. 7 illustrates this problem with respect to a bellows 10′ with an extension section 50′ and straight leg 30′, but without stiffening collar. The bellows 10′ will likely show buckling 70. In contrast, FIG. 8 shows the corresponding behaviour of a bellows 10 with a stiffening collar 52. The bellows 10 shows no buckling at larger angles between the two joint members of a transmission joint.

The combination of parameters mentioned can further improve the boot flexibility and can help to avoid buckling.

### LIST OF REFERENCE NUMERALS

10,10′ Bellows, boot
11,12 Seat
20 Inner space
21 Fastening region, large
22 Fastening region, small
23 Neck section
24,25,26 Wall
26′ Step
27,28 Ring
29,29′ Bulge
30,30′ Deformable wall
31 Straight leg
32 Fold
33 Curved leg
40 Transmission joint
41 Outer joint
42 Inner joint
43 Transmission ball
44 Internal gearing
45 Channel
50,50′ Extension section
51 Free edge
52 Collar, stiffener
60,61 Connection line
A,B Seat region
C Flexible region
D,d,T Diameter
X Longitudinal axis
a Length of stiffener region
b Thickness of straight leg
c Thickness of collar/stiffener region
α, βAngle
R1,R2,R3 Radius

1. Bellows (10) for the protection of parts of a transmission joint (40), wherein the bellows (10) is in the form of a hollow tubular body that is open at each of its ends and has a fastening region (21;22) at each of its open ends, wherein the two fastening regions (21;22) have cross-sections with different outer diameters and run essentially in parallel to a longitudinal axis (X) of the bellows (10), and these end side fastening regions (21;22) are interconnected by a deformable wall (30) that runs transverse to the longitudinal axis (X) of the bellows (10), wherein the deformable wall (30) forms at least one fold (32) between the two fastening regions (21;22),
characterized in that
a first fastening region (21) with the larger outer diameter D is extended in the direction of a second fastening region (22) with the smaller outer diameter d by means of a circumferential extension section (50) with a circular free edge (51) and the deformable wall (30) is connected to this extension section (50) at a first connection line (60) which is located before the free edge (51) of the extension section (50), wherein the outer surface of the extension section (50) is straight at least between the first connection line (60) and the free edge (51).

2. Bellows according to claim 1, wherein the outer surface of the first fastening region (21) and the outer surface of the extension section (50) merge steplessly into each other.

3. Bellows according to claim 1 or 2, wherein the outer surface of the extension section (50) is straight between the first fastening region (21) and the free edge (51).

4. Bellows according to one of claims 1 to 3, wherein the deformable wall (30) forms a straight leg (31) which is connected to the extension section (50) at the first connection line (60).

5. Bellows according to claim 4, wherein the thickness b of the straight leg (31) of the deformable wall (30) is smaller than the thickness c of the circular free edge (51) of the extension section (50).

6. Bellows according to one of the preceding claims 1 to 5, wherein the deformable wall (30) and the extension section (50) intersect at an angle a of 45° to 90° on the inside of the bellows (10).

7. Bellows according to one of the preceding claims 1 to 6, wherein a is the distance between the first connection line (60) and the free edge (51) of the extension section (50) and a=(0,02 to 0,2)×D.

8. Bellows according to one of the preceding claims 1 to 7, wherein T is the outer diameter of the extension section (50) at its free edge (51) and D>T.

9. Bellows according to one of the preceding claims 1 to 8, wherein the second fastening region (22) with the smaller outer diameter d is extended in the direction of the first fastening region (21) with the larger outer diameter D by means of a circumferential neck section (23) and the deformable wall (30) is connected to this neck section (23) at a second connection line (61).

10. Bellows according to claims 4 and 9, wherein the deformable wall (60) forms a fold (32) between the straight leg (31) and the neck section (23), whereby the fold (32) is a convex bulge on the outside of the bellows (10).

11. Bellows according to claim 10, wherein the radius R2 of the fold (32) on the inside of the bellows (10) is smaller than 12 mm, preferably smaller than 10 mm.

12. Bellows according to one of claims 9 to 11, wherein between the inner surface of the neck section (23) and the longitudinal axis X of the bellows (10) spans an angle β which is smaller than 15°.

13. Bellows according to one of claims 9 to 12, wherein the deformable wall (30) forms a curved leg (31) which is connected to the neck section (23) at the second connection line (61), whereby the curved leg (31) is concave on the outside of the bellows (10).

14. Bellows according to claim 13, wherein the curved leg (31) has a radius R1 on the outside of the bellows (10), which is smaller than 12 mm, preferably smaller than 10 mm.

15. Bellows according to one of claims 9 to 14, wherein the transition from the straight leg (31) of the deformable wall (30) to the fold (32) is curved and the radius R3 of this curved transition on the outside of the bellows (10) is smaller than 12 mm, preferably smaller than 10 mm.
